(19) United States
(12) Patent Application Publication
(10) Pub. No.: US 2004/0020311 A1
(43) Pub. Date: Feb. 5, 2004

(54) Method and apparatus for differential test probe retention with compliant Z-axis positioning

(76) Inventor: Rebecca Noel Cullion, Corvallis, OR (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/208,641

(22) Filed: Jul. 30, 2002

(51) Int. Cl. G01N 15/00

(52) U.S. Cl. 73/865.5

(57) ABSTRACT

An apparatus and a method for maintaining differential test probes in a predetermined configuration relative to each other are presented. The apparatus includes a compliant test probe retainer for maintaining at least two test probes in close proximity with each other without either probe twisting about a z-axis, which runs along the shafts of the two test probes. The at least two test probes having compliance along a z-axis to ensure optimal contact with test points on a device under test

### FIELD OF THE INVENTION

The present invention pertains generally to the field of electronic test instrumentation, and, more particularly, is related to differential test probe assemblies.

### BACKGROUND OF THE INVENTION

The increasing reliance upon computer systems to collect, process, and analyze data has led to the continuous improvement of the system components and associated hardware. New methods for increasing the speed of integrated circuit components while also increasing the functional density and reducing the physical size of integrated circuits are constantly being sought. As a result, it is not uncommon to see integrated circuits running at several GHz with pin spacing on the order of 10 mils apart.

Continuing advances in integrated circuit (“IC”) technology are a major cause of the demand for improved systems and methods to monitor and test IC devices. For example, IC devices that are mounted on printed circuit boards (“PCBs”) are being developed with higher component densities and smaller physical dimensions. In turn, the IC packages, i.e. the chip housing and electrical connectors, are being designed in more complex and compact configurations. A ball grid array (“BGA”), a chip package that uses an array of solder balls for the electrical connectors, is a typical example of such complex and compact ship package configurations. Other chip package configurations continue to use pins for electrical connectors, but the pins are smaller and arranged for tighter tolerances, and thus, such configurations are also becoming more complex and compact.

IC devices are also being developed that have increased performance characteristics. For example, as IC technology advances, central processing unit (“CPU”) chips that are utilized in computers are being developed to have increased processing speeds. Furthermore, communication buses that interconnect internal IC devices within a computer system are being developed to support increased speed and bandwidth performance.

The increased complexity and compactness of chip package configurations and the increased performance characteristics of chips and other IC devices created challenges to effective and efficient monitoring and testing of such devices. For example, to monitor or test an IC device, electrical signals are typically obtained from the device and input to monitoring or testing equipment, such as an oscilloscope or logic analyzer. A probe is typically connected to such monitoring or testing equipment and used to obtain the electrical signals by making physical contact with the electrical connectors or other probe points of the IC device, a process typically referred to as “probing.” Thus, in order to facilitate the effective and efficient monitoring or testing of IC devices, the probe must have physical and electrical features that overcome the challenges posed by the increased complexity and compactness of the chip package configurations and the increased performance characteristics of the IC devices.

Thus far, various systems and methods have been introduced in an attempt to provide physical and electrical features that overcome the challenges to effective and efficient monitoring or testing of IC devices, but shortcomings still persist. For example, differential probes (i.e., probes used for measuring the difference between two signals) have been introduced to provide high frequency differential probing of IC devices. Such differential probes have a fixed spacing between the probe tips that limits the configurations of IC device probe points that can be physically contacted for probing. One such differential test probe is the 1154A differential test probe offered by Agilent Technologies, Inc. having a principal place of business in Palo Alto, Calif.

In an attempt to overcome this shortcoming, “bent-wire” probe tip attachments have been introduced that can replace or modify the fixed-spacing probe tips. These bent-wire probe tip attachments can be attached to existing differential probes and bent to vary the spacing between the attached probe tips in order to contact the intended probe points of an IC device. But, the bent-wire probe tip attachments add undesirable parasitic impedance to the probe tip circuit which reduces the bandwidth (i.e., the high frequency signal reception capability) of the differential probe and, thereby, reduces the capability of the differential probe to accurately obtain signals from high frequency IC devices. Additionally, the positioning of the probe tips of the bent-wire probe tip attachments may undesirably vary during probing of an IC device and thereby result in loss of intended contact with the probe points as well as unintended contact with other probe points or create damaging short-circuits.

In the past, offset probe pins have been used that permitted the pins to swing freely. If the probe tips touch or come into too close of proximity with each other, there could be detrimental electrical characteristics, such as short-circuits, cross talk or capacitive coupling between the two probe tips. The only way in which the desired position of the probe pins could be maintained was to apply pressure to the probe pins while probing. The probe pins have a tendency to rotate and not stay in the proper configuration.

Accordingly, it should be appreciated that there is a need for improved systems and methods that address the aforementioned, as well as other, shortcomings of existing systems and methods of probing IC devices in the test environment. Specifically, there is a need in the industry for a differential electrical test probing system and method that permits user defined probe tip spacing to control parasitic capacitance and optimal test probe positioning to IC device test points. Further, there is a need in the industry for a differential electrical test probing system and method that permits Z-axis compliance along the shaft of the test probe to facilitate optimal test probe to IC device under test contact. Further, there is a need for a differential test probing system and method that permits probe pins to be set in the optimal testing position by the user and physical pressure applied to the probe pins during testing without the probe pins leaving the desired probing position.

### SUMMARY OF THE INVENTION

Accordingly, it is an object of the invention to achieve a z-axis compliant differential probe pin assembly and method.

It is also an object of the invention to provide a differential probe pin assembly and method that maintains a preset configuration until the user changes it.

It is an object of the invention to provide a differential probe pin assembly and method that maintains the proper spacing between the probe pins as the probe pins move along the z-axis.

The present invention achieves these and other advantageous objectives, with a compliant differential probe pin retainer system and method.

An apparatus for maintaining at least two test probes in predetermined positions relative to each other and against twisting about a z-axis that runs along the shafts of the test probes. The apparatus comprises a compliant test probe retainer for retaining at least two test probe barrels having test probe tips in predetermined positions relative to each other; at least two holes in said compliant test probe retainer for inserting test probe barrels; and outside walls for maintaining said complaint test probe retainers relative shape.

A method for retaining at least two electronic test probes in predetermined positions relative to each other. The method comprises providing at least two electronic test probes; providing a compliant test probe retainer having at least two holes spaced proximate to each other; and sliding said at least two electronic test probes into at least two holes in said compliant test probe retainer.

A method for probing test points with a differential test probe device having at least two test probe barrels, each test probe barrel having a test probe tip thereon. The method comprises maintaining said test probe tips in predetermined locations relative to each other with a compliant retainer, wherein said test probe barrels are maintained in relatively constant predetermined positions against rotating about a z-axis running along said test probe barrels, and further wherein said test probe tips are held in relatively constant predetermined distance and positions relative to each other; and positioning said test probe tips in contact with test points on a device under test, wherein said test probes are able to comply with said test points along a z-axis running along said test probe barrels

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a perspective view of a differential test probe with a compliant retainer in accordance with the present invention;

FIG. 2 illustrates a perspective view of a complaint test probe retainer in accordance with the present invention;

FIG. 3 illustrates a plan view of a complaint test probe retainer in accordance with the present invention;

FIG. 4 illustrates a side view of a compliant test probe retainer in accordance with the present invention; and

FIG. 5 illustrates a plan view of a complaint test probe retainer in accordance with a second embodiment of the present invention.

### DETAILED DESCRIPTION OF THE INVENTION

As shown in the drawings for purposes of illustration, the present invention relates to techniques for providing a compliant differential test probe retainer system and method.

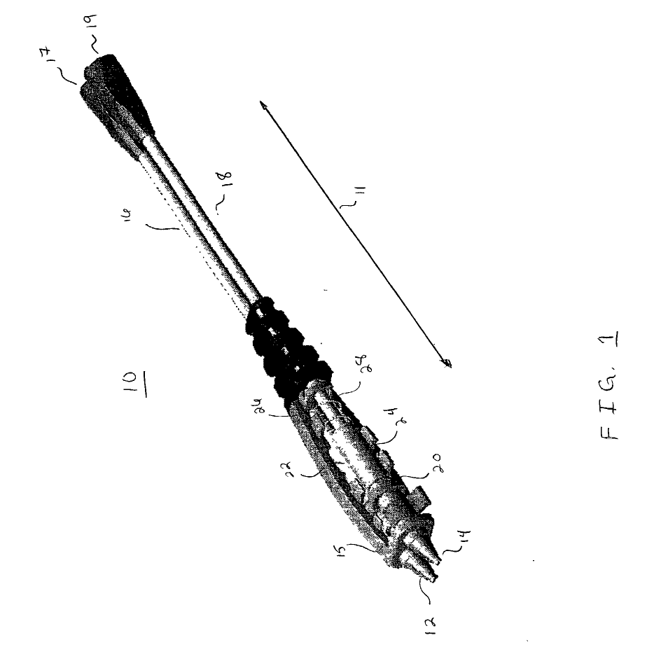

Turning now to the drawings, FIG. 1 illustrates a differential test probe 10. Differential test probe 10 includes test pin tips 12 and 14, test probe barrels 22 and 24, and test probe cables 16 and 18. Test pin tips 12 and 14 are capable of making electrical contact between test probe barrels 22 and 24 and test points on an IC device under test. Test probe cables 16 and 18 are for signal transmission between the test probe pins and the test and measurement equipment (not shown). Test probe cables 16 and 18 connect to test and measurement equipment (not shown) via cable connectors 17 and 19. It will be appreciated that test probe barrels 22 and 24 include z-axis compression means 26 and 28 for urging test probe barrels 22 and 24 into electrical contact with test points on an IC device under test.

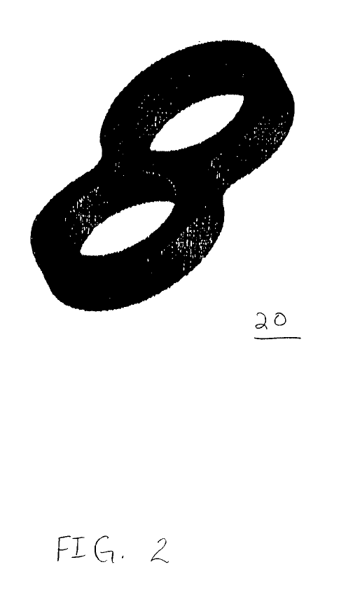

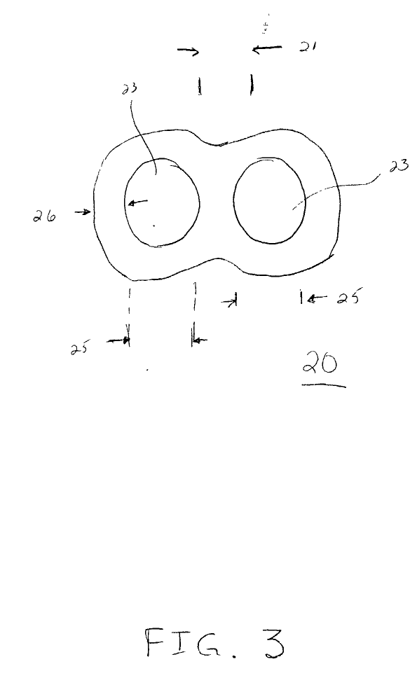

Differential test probe 10 according to the present invention includes a compliant retainer 20. As will be more thoroughly described below with reference to FIGS. 2-4, compliant retainer 20 maintains test probe barrels 22 and 24 in spatial and rotational position relative to each other as determined by the user, while permitting z-axis (11) compliance during testing. The z-axis 11 is the axis that runs along the test probe barrels or shafts 22 and 24. Test probe barrels 22 and 24 are encased in a probe housing 15, which is only partially shown in order to illustrate compliant retainer 20 and related probe features.

FIGS. 2-4 show a perspective view, a plan view, and a side view of compliant retainer 20. Compliant retainer 20 has two holes 23 with diameters 25 just slightly narrower than the diameter of test probe barrels 22 and 24. Compliant retainer 20 has a distance 21 between holes 23. The distance 21 between holes 23 is predetermined to optimize the distance between test probe tip 12 and 14 to prevent cross talk, capacitive coupling, shorting and other electrical disadvantages. Test probe tips 12 and 14 also must be positioned relative to each other so that both tips may contact the appropriate, fine-pitched test points on the device under test.

Compliant retainer 20 may be made of any compliant material, such as rubber, latex rubber, soft plastic, silicon. Complaint retainer 20 may be made of a more rigid material, such as a harder plastic that is cut along an outside wall 26 to permit z-axis 11 compliance. Compliant retainer 20 may be manufactured by injection molding, stamping, or cutting the design into the compliant material.

In one embodiment, if test probe barrels 22 and 24 are 0.1875 inches in diameter, the diameter 25 of the compliant retainer 20 holes 23 may be approximately 0.172 inches. In this embodiment, compliant retainer 20 is essentially shaped in a FIG. 8. The distance 21 between compliant retainer 20 holes 23 is approximately 0.056 inches. The outside walls 26 and thickness 27 of complaint test probe retainer 20 may be any dimension necessary to ensure compliance without breakage. For example, outside walls 26 may be approximately at least 0.12 inches and thickness 27 may be approximately 0.031 to 0.094 inches for latex rubber. Test probe barrels 22 and 24 may be inserted into holes 23 of compliant retainer 20 to approximately 1/16^{th} of an inch and maintains the test probe tips 12 and 14 spaced approximately 0.025 inches apart in their closet position and 0.2275 inches apart at their furthest position relative to each other.

Accordingly, compliant retainer 20 will provide sufficient friction to permit the user to position the spacing of the test probe tips 12 and 14 and maintain that position when the test probe tips are brought into compressive contact with test points on an IC device under test. Such an arrangement will provide sufficient friction to the test probe barrels 22 and 24 to maintain their positions relative to each other with respect to rotational twisting around the z-axis 11 and the relative spacing between test probe tips 12 and 14, and at the same time, permit z-axis 11 compliance to ensure electrical contact with the relative test points of the device under test.

It will be appreciated from the above detailed description that compliant retainer 20 may come in various shapes and sizes depending upon the diameter of test probe barrels 22 and 24, the angle of test probe tips 12 and 14, the spacing of relevant test points, and other specific test design electrical and physical features. Also, the outside wall 26 and thickness 27 dimensions may change as necessary, depending upon the material used to manufacture compliant retainer 20, to ensure compliance without breakage and general shape maintenance.

It will be readily appreciated by those skilled in the art, that the dimensions of the compliant retainer 20 may vary according to the material of the compliant retainer 20, the diameter and dimensions of the relevant test probe barrels 22 and 24, and the desired friction necessary to maintain the position of the test probe tips 12 and 14, in a particular embodiment or application. In one embodiment, the ratio of the hole diameter 23 of compliant retainer 20 to the test probe barrel 22 and 24 diameter is approximately 0.9.

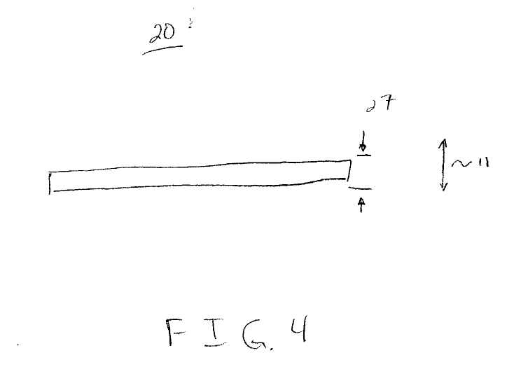

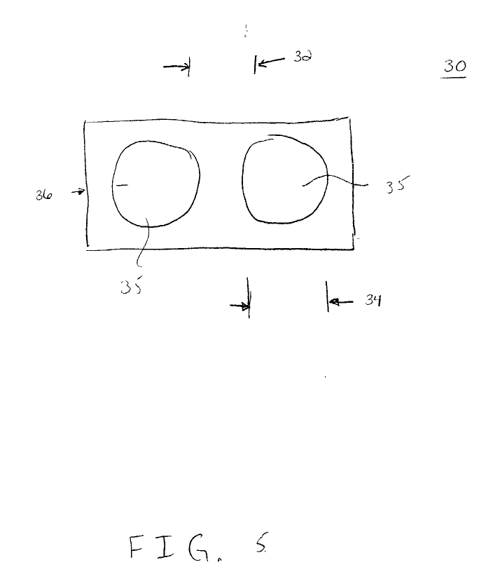

For example, referring to FIG. 5, compliant retainer 30 may be rectangular in shape, so long as the diameter 34 of holes 35 ensures a snug fit with test probe barrels 22 and 24, the distance 32 between holes 35 is appropriate to maintain the necessary distance between test probe tips 12 and 14, and outside walls 36 and the thickness (not shown in this view, shown as 27 in FIG. 4) is appropriate to maintain the shape and z-axis 11 compliance of the compliant retainer 30 without breakage during use.

Although this preferred embodiment of the present invention has been disclosed for illustrative purposes, those skilled in the art will appreciate that various modifications, additions and substitutions in size, shape, design and materials are possible, without departing from the scope and spirit of the present invention, resulting in equivalent embodiments that remain within the scope of the appended claims.

What is claimed is:

1. A device comprising:
a compliant test probe retainer for retaining at least two test probe barrels having test probe tips in predetermined positions relative to each other;
at least two holes in said compliant test probe retainer for inserting test probe barrels; and
outside walls for maintaining said complaint test probe retainer's relative shape.

2. A device in accordance with claim 1, wherein said compliant test probe retainer is shaped like a FIG. 8.

3. A device in accordance with claim 1, further comprising a predetermined distance between said at least two holes such that said two test probe barrels and test probe tips are held in predetermined locations relative to each other when inserted into said at least two holes in said compliant retainer.

4. A device in accordance with claim 3, wherein said compliant test probe retainer is compliant along the z-axis, such that said at least two test probe tips may maintain contact with a device under test when held in physical contact thereto.

5. A device in accordance with claim 1, wherein said compliant test probe retainer is a compliant material.

6. A device in accordance with claim 5, wherein said compliant test probe retainer is latex rubber.

7. A device in accordance with claim 5, wherein said compliant test probe retainer is rubber.

8. A device in accordance with claim 5, wherein said compliant test probe retainer is soft plastic.

9. A device in accordance with claim 5, wherein said compliant test probe retainer is silicon.

10. A device in accordance with claim 1, wherein said compliant test probe retainer is comprised of a single component.

11. A method for retaining at least two electronic test probes in predetermined positions relative to each other, said method comprising:
providing at least two electronic test probes;
providing a compliant test probe retainer having at least two holes spaced proximate to each other; and
sliding said at least two electronic test probes into at least two holes in said compliant test probe retainer.

12. A method in accordance with claim 11, wherein said compliant test probe retainer comprises a compliant material.

13. A method in accordance with claim 11, wherein said two electronic test probes are compliant along a z-axis relative to each other while held in said compliant retainer.

14. A method for probing test points with a differential test probe device having at least two test probe barrels, each test probe barrel having a test probe tip thereon, said method comprising:
maintaining said test probe tips in predetermined locations relative to each other with a compliant retainer, wherein said test probe barrels are maintained in relatively constant predetermined positions against rotating about a z-axis running along said test probe barrels, and further wherein said test probe tips are held in relatively constant predetermined distance and positions relative to each other; and
positioning said test probe tips in contact with test points on a device under test, wherein said test probes are able to comply with said test points along a z-axis running along said test probe barrels.
